(19) United States
(12) Patent Application Publication
(10) Pub. No.: US 2026/0117019 A1
(43) Pub. Date: Apr. 30, 2026

(54) HYDROLYSIS OF POLY(HYDROXYALKANOATES) IN AQUEOUS DISPERSIONS

(71) Applicant: Danimer IPCo, LLC, Bainbridge, GA (US)

(72) Inventors: Karson Durie, Athens, GA (US); Joe B. Grubbs, Bishop, GA (US); Matthew Vinston Hilliard, Camilla, GA (US); Gary Enrique Broyles, Bainbridhe, GA (US); Donaldson Joseph Armento, Atlanta, GA (US); Matthew John Hoehne, Lexington, KY (US)

(21) Appl. No.: 19/471,770

(22) PCT Filed: Apr. 18, 2024
(86) PCT No.: PCT/US2024/025204

§ 371 Date: Oct. 2, 2025

Related U.S. Application Data
(60) Provisional application No. 63/461,054, filed on Apr. 21, 2023.

(51) Int. Cl. C08G 63/06; C08G 63/81; C08J 3/05

(52) U.S. Cl. CPC C08G 63/06; C08G 63/81; C08J 3/05; C08J 2367/04

(57) ABSTRACT

A method for producing a polyhydroxyalkanoate having a desired weight average molecular weight is disclosed. A dispersion is prepared, which includes polyhydroxyalkanoate having an initial weight average molecular weight and a solvent. A portion of the polyhydroxyalkanoate is then hydrolyzed in the dispersion for a specified reaction time interval so that the weight average molecular weight of the polyhydroxyalkanoate is reduced to a final weight average molecular weight, which is less than the initial weight average molecular weight. The hydrolysis reaction is then quenched so that a polyhydroxyalkanoate having a desired weight average molecular weight is produced.

### FIELD

This disclosure relates to biodegradable polymeric composition. More particularly, this disclosure relates to methods for producing a polyhydroxyalkanoate, having a desired molecular weight, in an aqueous dispersion.

### BACKGROUND

Poly(hydroxyalkanoates) are a class of biodegradable and/or compostable polymers that may be used in various applications. For instance, poly(hydroxyalkanoates) may be used in injection molding or in aqueous coatings. Poly(hydroxyalkanoates) are typically prepared by bio-fermentation processes, and the weight average molecular weight of the poly(hydroxyalkanoates) so produced may differ depending upon the microorganism species used in the fermentation, the choice of carbon source fed to the microorganisms, and so forth.

Poly(hydroxyalkanoates) having high weight average molecular weights may be optimal for certain applications, such as injection molding. However, for other applications, such as in aqueous coatings, a poly(hydroxyalkanoate) having a lower average molecular weight may be more desirable. Consequently, it is typically necessary to use differing starting poly(hydroxyalkanoate) resins for different end applications so that the average molecular weight of the resin may be better tailored to the end use. This leads to the need to prepare differing poly(hydroxyalkanoate) resins using differing microorganisms and/or different fermentation conditions.

In contrast to this, it would be advantageous and desirable if a common supply of poly(hydroxyalkanoates) resin could be prepared using one set of fermentation conditions and if this common poly(hydroxyalkanoates) resin could then be modified and optimized for use in different end-use applications, such as injection molding and preparation of aqueous coatings.

More specifically, it would be desirable to provide a method for partially hydrolyzing a poly(hydroxyalkanoate) resin having a high initial weight average molecule to quickly provide a poly(hydroxyalkanoate) resin having a significantly reduced weight average molecular weight, wherein the process allows for a high degree of control over the molecular weight and the polydispersity of the final poly(hydroxyalkanoate) resin.

### SUMMARY OF THE INVENTION

The above and other needs are met by a method for producing a polyhydroxyalkanoate having a desired weight average molecular weight according to the present disclosure.

In a first aspect, the present disclosure provides a method for producing a polyhydroxyalkanoate. According to one embodiment, this method includes an initial step of preparing a dispersion, which includes from about 10 to about 90 weight percent of at least one polyhydroxyalkanoate and from about 10 to 90 weight percent of a solvent. The at least one polyhydroxyalkanoate has an initial weight average molecular weight from about 500,000 Daltons to about 5,000,000 Daltons. The solvent is selected from the group consisting of water, saturated and unsaturated alkyl alcohols having from 1 to 10 carbon atoms, and mixtures thereof.

The method also includes a step of adding a base to the dispersion in an amount sufficient to provide a pH in the dispersion from about 12 to about 14. A portion of the at least one polyhydroxyalkanoate is then hydrolyzed by reaction with the base for a reaction time interval. In this way, the weight average molecular weight of the at least one polyhydroxyalkanoate is reduced to a final weight average molecular weight that is less than the initial weight average molecular weight.

The method also includes a step of stopping the reaction by the addition of a quenching acid in an amount sufficient to establish a pH less than about 12.0 (preferably from about 5.0 to about 7.5) in the dispersion and a step of filtering precipitated salts from the dispersion.

According to the method, all the aforementioned weight average molecular weights are determined in accordance with ASTM D5296.

According to the present method, the at least one polyhydroxyalkanoate in the dispersion is made up of particles having an average particles size from about particles having an average particle size from about 10 nanometers to about 50 microns, as determined using dynamic light scattering in accordance with ISO 22412:2017.

In certain embodiments, the initial weight average molecular weight of the at least one polyhydroxyalkanoate is preferably from about 500,000 to about 5,000,000 Daltons, as determined by ASTM D5296. Also, in some embodiments, the final weight average molecular weight of the at least one polyhydroxyalkanoate is preferably from about 50,000 to 700,000 Daltons, more preferably 250,000 to about 500,000 Daltons and even more preferably from about 350,000 to about 400,000 Daltons, as determined by ASTM D5296.

According to some embodiments, the final weight average molecular weight of the at least one polyhydroxyalkanoate is preferably from about 10 to about 95 percent of the initial weight average molecular weight, wherein both weight average molecular weights are determined in accordance with ASTM D5296. More preferably, the final weight average molecular weight is from about 35 to about 70 percent of the initial weight average molecular weight.

In accordance with certain embodiments, the solvent is preferably selected from the group consisting of water, methanol, ethanol, isopropanol, and mixtures thereof. In some instances, the solvent is made up of ethanol, and the reaction time interval is from about 2 to about 60 minutes, more preferably from about 5 to about 30 minutes. In other instances, the solvent is made up of water, and the reaction time interval is from about 1 to about 48 hours.

According to certain embodiments, the base is preferably a strong base with a pK_{b} less than 1. In some embodiments, the base may, for example, be selected from the group consisting of alkali hydroxide, alkaline earth hydroxides, and mixtures thereof. More preferably, the base is selected from the group consisting of sodium hydroxide, potassium hydroxide, and mixtures.

In other embodiments, the base is preferably a weak base having a pK_{b} from about 1 to about 5. In certain embodiments, for instance, the base may be selected from the group consisting of ammonium hydroxide, aniline, ammonia, and mixtures thereof.

According to some embodiments, the dispersion preferably has a solids content from about 5 to about 20 percent prior to the addition of the base and more preferably from about 10 to about 15 percent.

In some instances, the quenching acid is preferably selected from the group consisting of hydrochloric acid, sulfuric acid, nitric acid, hydrobromic acid, hydroiodic acid, perchloric acid, chloric acid, acetic acid, citric acid, phosphoric acid, glycolic acid, nitrous acid, sulfurous acid, oxalic acid, benzoic acid, formic acid, and mixtures thereof.

In certain embodiments, the hydrolyzing is preferably carried out at a temperature from about 20° C. to about 60° C.

In some embodiments, the dispersion is preferably also made up of at least one surfactant selected from the group consisting of anionic surfactants, cationic surfactants, amphoteric surfactants, nonionic surfactants, and mixtures thereof.

According to some embodiments, the dispersion is prepared using sonication, low-shear mixing, and/or ultra-high-shear mixing.

Moreover, in some embodiments, the method preferably includes a further step, prior to preparing the dispersion, of synthesizing the at least one polyhydroxyalkanoate. This synthesizing is carried out by: (1) mixing a biomass comprising bacteria with a carbon source, (2) fermenting the biomass and the carbon so that the bacteria of the biomass consume at least a portion of the carbon source and synthesize at least one poly(hydroxyalkanoate) having an initial weight average molecular weight from about 500,000 Daltons to about 5,000,000 Daltons, and (3) separating the at least one poly(hydroxyalkanoate) from the biomass.

In some instances, wherein the polyhydroxyalkanoate produced according to the present method has a polydispersity index (PDI) from about 1.0 to about 5.0 and preferably from about 2.0 to about 4.0 when measured via gel permeation chromatography according to ASTM D5296.

In a second aspect, the present disclosure provides a further method for producing a polyhydroxyalkanoate. According to one embodiment, this method includes an initial step of preparing a dispersion, which includes from about 10 to about 90 weight percent of at least one polyhydroxyalkanoate and from about 10 to 90 weight percent of a solvent. The at least one polyhydroxyalkanoate has an initial weight average molecular weight from about 500,000 Daltons to about 5,000,000 Daltons. The solvent is selected from the group consisting of water, saturated and unsaturated alkyl alcohols having from 1 to 10 carbon atoms, and mixtures thereof.

The method also includes a step of adding an acid to the dispersion in an amount sufficient to provide a pH in the dispersion from about 1 to about 3. A portion of the at least one polyhydroxyalkanoate is then hydrolyzed by reaction with the acid for a reaction time interval. In this way, the weight average molecular weight of the at least one polyhydroxyalkanoate is reduced to a final weight average molecular weight which is less than the initial weight average molecular weight.

The method also includes a step of stopping the reaction by the addition of a quenching base in an amount sufficient to establish a pH from about 5.0 to about 7.5 in the dispersion and a step of filtering precipitated salts from the dispersion.

According to the method, all the aforementioned weight average molecular weights are determined in accordance with ASTM D5296.

According to the present method, the at least one polyhydroxyalkanoate in the dispersion is made up of particles having an average particles size from about particles having an average particle size from about 10 nanometers to about 50 microns, as determined using dynamic light scattering in accordance with ISO 22412:2017.

In certain embodiments, the initial weight average molecular weight of the at least one polyhydroxyalkanoate is preferably from about 500,000 to about 5,000,000 Daltons, as determined by ASTM D5296. Also, in some embodiments, the final weight average molecular weight of the at least one polyhydroxyalkanoate is preferably from about 300,000 to about 500,000 Daltons, as determined by ASTM D5296.

According to some embodiments, the final weight average molecular weight of the at least one polyhydroxyalkanoate is preferably from about 10 to about 95 percent of the initial weight average molecular weight, wherein both weight average molecular weights are determined in accordance with ASTM D5296. More preferably, the final weight average molecular weight is preferably from about 35 to about 70 percent of the initial weight average molecular weight.

In accordance with certain embodiments, the solvent is preferably selected from the group consisting of water, methanol, ethanol, isopropanol, and mixtures thereof. In some instances, the solvent is made up of ethanol, and the reaction time interval is from about 2 to about 60 minutes, more preferably from about 5 to about 30 minutes. In other instances, the solvent is made up of water, and the reaction time interval is from about 1 to about 48 hours.

According to certain embodiments, the acid is preferably a strong acid having a pKₐ which is less than 0. In some embodiments, the acid may, for example, be selected from the group consisting of hydrochloric acid, sulfuric acid, nitric acid, hydrobromic acid, hydroiodic acid, perchloric acid, chloric acid, and mixtures thereof.

In other embodiments, the acid is preferably a weak acid having a pKₐ from about 14 to about 0. In certain embodiments, for instance, the acid may be selected from the group consisting of acetic acid, citric acid, nitrous acid, phosphoric acid, glycolic acid, sulfurous acid, oxalic acid, benzoic acid, formic acid, and mixtures thereof.

According to some embodiments, the dispersion preferably has a solids content from about 5 to about 20 percent prior to the addition of the acid, and more preferably from about 10 to about 15 percent.

In some instances, the quenching base is preferably selected from the group consisting of ammonium hydroxide, aniline, ammonia, and mixtures thereof.

In certain embodiments, the hydrolyzing is preferably carried out at a temperature from about 20° C. to about 60° C.

In some embodiments, the dispersion is preferably also made up of at least one surfactant selected from the group consisting of anionic surfactants, cationic surfactants, amphoteric surfactants, nonionic surfactants, and mixtures thereof.

According to some embodiments, the dispersion is prepared using sonication, low-shear mixing, and/or ultra-high-shear mixing.

Moreover, in some embodiments, the method preferably includes a further step, prior to preparing the dispersion, of synthesizing the at least one polyhydroxyalkanoate. This synthesizing is carried out by: (1) mixing a biomass comprising bacteria with a carbon source, (2) fermenting the biomass and the carbon so that the bacteria of the biomass consume at least a portion of the carbon source and synthesize at least one poly(hydroxyalkanoate) having an initial weight average molecular weight from about 500,000 Daltons to about 5,000,000 Daltons, and (3) separating the at least one poly(hydroxyalkanoate) from the biomass.

In some instances, wherein the polyhydroxyalkanoate produced according to the present method has a polydispersity index (PDI) from about 1.0 to about 5.0 and preferably from about 2.0 to about 4.0 when measured via gel permeation chromatography according to ASTM D5296.

### BRIEF DESCRIPTION OF THE DRAWINGS

Further advantages of the invention are apparent by reference to the detailed description when considered in conjunction with the FIGURES, wherein:

FIG. 1 is a graph illustrating the rate of poly(hydroxyalkanoates) hydrolysis according to one embodiment of the present disclosure;

### DETAILED DESCRIPTION

The present disclosure provides a method for preparing a polyhydroxyalkanoate having a target weight average molecular weight. According to this method, a common supply of poly(hydroxyalkanoates) resin may be prepared and then modified and optimized for use in different end-use applications which require differing weight average molecular weights for the poly(hydroxyalkanoates).

In general, the method of the present disclosure includes a step of preparing a dispersion of at least one polyhydroxyalkanoate, having an initial weight average molecular weight, in a solvent. A portion of the at least one polyhydroxyalkanoate is then hydrolyzed for a specified reaction time interval. In this way, the weight average molecular weight of the at least one polyhydroxyalkanoate is reduced to a final weight average molecular weight that is less than the initial weight average molecular weight. After the specified reaction time interval, the hydrolysis reaction is quenched to provide a final polyhydroxyalkanoate having the desired weight average molecular weight.

All weight average molecular weights referenced herein are determined in accordance with ASTM D5296 unless otherwise noted.

The initial weight average molecular weight of the at least one polyhydroxyalkanoate (before hydrolysis) is typically from about 500,000 Daltons to about 5,000,000 Daltons. More preferably, the initial weight average molecular weight of the at least one polyhydroxyalkanoate is from about 1,000,000 to about 2,000,000 Daltons.

After the hydrolysis reaction, the final weight average molecular weight of the at least one polyhydroxyalkanoate is typically from about 50,000 to 700,000 Daltons, more preferably 250,000 to about 500,000 Daltons, and even more preferably from about 350,000 to about 400,000 Daltons.

In some instances, the final weight average molecular weight of the at least one polyhydroxyalkanoate is preferably from about 10 to about 95 percent of the initial weight average molecular weight, wherein both weight average molecular weights are determined in accordance with ASTM D5296. More preferably, the final weight average molecular weight is from about 35 to about 70 percent of the initial weight average molecular weight.

In some instances, the method also includes an initial step, prior to the preparation of any dispersion, of synthesizing the at least one polyhydroxyalkanoate. This synthesis is carried out in a fermentation bioreactor and includes (1) mixing a biomass comprising bacteria with a carbon source, (2) fermenting the biomass and the carbon so that the bacteria of the biomass consume at least a portion of the carbon source and synthesize at least one poly(hydroxyalkanoate) having an initial weight average molecular weight from about 500,000 Daltons to about 5,000,000 Daltons, and (3) separating the at least one poly(hydroxyalkanoate) from the biomass.

Suitable bacteria which may be included in the biomass include Pseudomonas sp., Ralstonia sp., Bacillus sp., and Cupriavidus sp. Suitable carbon sources which may be fed to the bacteria during the fermentation include vegetable oils such as but not limited to rapeseed, canola, soybean, and palm oils, carbohydrate sources, like sugars, and/or glycerol.

As noted above, the method of the present disclosure includes a step of preparing a dispersion of at least one polyhydroxyalkanoate, having an initial weight average molecular weight, in a solvent. More particularly, the dispersion includes from about 10 to about 90 weight percent of at least one polyhydroxyalkanoate and from about 10 to 90 weight percent of a solvent. More preferably, the dispersion includes 10 to about 60 weight percent of at least one polyhydroxyalkanoate and from about 40 to 90 weight percent of a solvent.

Various polyhydroxyalkanoate may be used in the preparation of the dispersion. In some instances, the dispersion may comprise a polyhydroxyalkanoate homopolymer, such as polyhydroxybutyrate. In other instances, the dispersion may comprise a polyhydroxyalkanoate copolymer, such as poly(hydroxybutyrate-co-hydroxyhexanoate) or a polyhydroxyalkanoate terpolymer. The dispersion may also comprise a mixture of polyhydroxyalkanoate homopolymers, copolymers, and/or terpolymers.

As noted above, the at least one polyhydroxyalkanoate has an initial weight average molecular weight from about 500,000 Daltons to about 5,000,000 Daltons.

Typically, the solvent of the dispersion is selected from the group consisting of water, saturated and unsaturated alkyl alcohols having from 1 to 10 carbon atoms, and mixtures thereof. In some embodiments, the solvent is preferably selected from the group consisting of water, methanol, ethanol, isopropanol, and mixtures thereof. Particularly preferred solvents include water, ethanol, and mixtures thereof.

In accordance with certain embodiments, the dispersion also preferably comprises at least one surfactant. This surfactant may be selected from the group consisting of anionic surfactants, cationic surfactants, amphoteric surfactants, nonionic surfactants, and mixtures thereof. Particularly preferred surfactants include polysorbates and polyether siloxanes.

When present, the amount of surfactant in the dispersion is typically from about 0.01% to about 1.0%.

When prepared, the dispersion typically the dispersion preferably has a solids content from about 5 to about 20 percent prior to the addition of the base, and more preferably from about 10 to about 15 percent.

In preparing the dispersion, the aforementioned components are thoroughly mixed to stably and uniformly disperse the polyhydroxyalkanoate solids in the solvent. Preferably, the dispersion is mixed using sonication, low-shear mixing (such as with a paddle mixer), and/or ultra-high shear mixing (such as with a Cowles blade mixer or a rotor-stator mixer).

When the dispersion is prepared in this matter, the at least one polyhydroxyalkanoate in the dispersion preferably comprises particles having an average particles size from about particles having an average particle size from about 10 nanometers to about 50 microns, as determined using dynamic light scattering in accordance with ISO 22412:2017.

Without being bound by theory, it is believed that this relatively small average particle size for the polyhydroxyalkanoate in the dispersion facilitates the quick and uniform hydrolysis of the polyhydroxyalkanoate, as discussed in more detail below.

Again, once the dispersion is prepared, the method includes a step of hydrolyzing a portion of the at least one polyhydroxyalkanoate for a specified reaction time interval. In this way, the weight average molecular weight of the at least one polyhydroxyalkanoate is reduced to a final weight average molecular weight which is less than the initial weight average molecular weight.

In certain embodiments, this hydrolysis is base-catalyzed. Thus, the method includes a step of adding a base to the dispersion in an amount sufficient to provide a pH in the dispersion from about 12 to about 14. A portion of the at least one polyhydroxyalkanoate is then hydrolyzed by reaction with the base for a reaction time interval.

A variety of bases may be used to catalyze the hydrolysis reaction. For instance, in some embodiments, the base is preferably a strong base having a pKb which is less than 1. This strong base may, for instance, be selected from the group consisting of alkali hydroxides, alkaline earth hydroxides, and mixtures thereof. More preferably, the base is selected from the group consisting of sodium hydroxide, potassium hydroxide, and mixtures.

In other embodiments, however, the base is preferably a weak base having a pK_{b} from about 1 to about 5. In certain embodiments, for instance, the base may be selected from the group consisting of ammonium hydroxide, aniline, ammonia, and mixtures thereof.

In general, this base-catalyzed hydrolysis is preferably carried out at a temperature from about 20° C. to about 60° C. More preferably, the reaction is carried out at a temperature from about 30° C. to about 50° C.

The hydrolysis reaction is allowed to proceed for a specified reaction time interval so that a portion (but not all) of the at least one polyhydroxyalkanoate is hydrolyzed to provide a final polyhydroxyalkanoate having a desired final weight average molecular weight which is less than the initial weight average molecular weight.

The length of the reaction time interval has been found to vary depending on the solvent used in the preparation of the dispersion. For instance, in some instances, the solvent is made up of ethanol, and the reaction time interval is from about 2 to about 60 minutes, more preferably from about 5 to about 30 minutes. In other instances, the solvent is made up of water, and the reaction time interval is from about 1 to about 48 hours.

Once the specified reaction time interval has elapsed, the method also includes a step of stopping the reaction by the addition of a quenching acid in an amount sufficient to establish a pH less than about 12.0 (preferably from about 5.0 to about 7.5) in the dispersion. For this reaction quenching step, suitable quenching acids may preferably be selected from the group consisting of hydrochloric acid, sulfuric acid, nitric acid, hydrobromic acid, hydroiodic acid, perchloric acid, chloric acid, acetic acid, citric acid, phosphoric acid, glycolic acid, nitrous acid, sulfurous acid, oxalic acid, benzoic acid, formic acid, and mixtures thereof.

In this way, the hydrolysis reaction is quenched to provide a final polyhydroxyalkanoate having the desired weight average molecular weight.

In alternative embodiments, the hydrolysis reaction may be acid-catalyzed. In such embodiments, the method includes a step of adding an acid to the dispersion in an amount sufficient to provide a pH in the dispersion from about 1 to about 3. A portion of the at least one polyhydroxyalkanoate is then hydrolyzed by reaction with the acid for a reaction time interval. In this way, the weight average molecular weight of the at least one polyhydroxyalkanoate is reduced to a final weight average molecular weight which is less than the initial weight average molecular weight.

In some embodiments, the acid-catalyzed hydrolysis is preferably carried out using a strong acid, for instance, an acid having a pKₐ which is less than 0. In some embodiments, for instance, the acid may, for example, be selected from the group consisting of hydrochloric acid, sulfuric acid, nitric acid, hydrobromic acid, hydroiodic acid, perchloric acid, or chloric acid, and mixtures thereof.

In other embodiments, the hydrolysis is preferably catalyzed using a weak acid. For example, the acid may be a weak acid having a pKₐ from about 14 to about 0. In certain embodiments, for instance, the acid may be selected from the group consisting of acetic acid, citric acid, phosphoric acid, glycolic acid, nitrous acid, sulfurous acid, oxalic acid, benzoic acid, formic acid, and mixtures thereof.

As with the base-catalyzed reaction, this acid-catalyzed hydrolysis is preferably carried out at a temperature from about 20° C. to about 60° C. More preferably, the reaction is carried out at a temperature from about 30° C. to about 50° C.

The hydrolysis reaction is allowed to proceed for a specified reaction time interval so that a portion (but not all) of the at least one polyhydroxyalkanoate is hydrolyzed to provide a final polyhydroxyalkanoate having a desired final weight average molecular weight which is less than the initial weight average molecular weight.

The method then includes a step of stopping the reaction by the addition of a quenching base in an amount sufficient to establish a pH from about 5.0 to about 7.5 in the dispersion. In certain embodiments, this quenching base is preferably selected from the group consisting of ammonium hydroxide, aniline, ammonia, and mixtures thereof.

After the reaction catalyst is quenched (whether the base catalyst quenched with acid or the acid catalyst quenched with base), an amount of salts are formed and will typically precipitate out of the dispersion. Thus, after quenching, the method of the present disclosure also includes a step of filtering precipitated salts from the dispersion. For instance, the precipitated salts may be filtered with a plate and frame filter press.

Advantageously, according to the method of the present disclosure, a common supply of poly(hydroxyalkanoate) resin having a high initial weight average molecular weight may be prepared, and then portions of this common poly(hydroxyalkanoates) resin may be optimized for use in different end-use applications by hydrolyzing a portion of the resin to reduce the weight average molecular weight of the resin. For instance, from a common supply of high molecular weight poly(hydroxyalkanoate) resin, a first portion of the resin may be hydrolyzed to provide a dispersion having a relatively low weight average molecular weight suitable for aqueous coatings and a second portion of the resin may be left with a substantially higher weight average molecular weight which is suitable for injection molding.

Moreover, the final poly(hydroxyalkanoate) resin prepared according to the present method advantageously exhibits a relatively narrow molecular weight distribution, characterized by a polydispersity index (PDI) from about 1.0 to about 5.0 and preferably from about 2.0 to about 4.0 when measured via gel permeation chromatography according to ASTM D5296. The low PDI value demonstrates the precise control of the present method when degrading poly(hydroxyalkanoate).

### Embodiments

The present disclosure is also further illustrated by the following embodiments:

Embodiment 1. A method for producing a polyhydroxyalkanoate, comprising the steps of:
preparing a dispersion comprising from about 10 to about 90 weight percent of at least one polyhydroxyalkanoate, having an initial weight average molecular weight from about 500,000 Daltons to about 5,000,000 Daltons, and from about 10 to 90 weight percent of a solvent selected from the group consisting of water, saturated and unsaturated alkyl alcohols having from 1 to 10 carbon atoms, and mixtures thereof;
adding a base to the dispersion in an amount sufficient to provide a pH in the dispersion from about 12 to about 14;
hydrolyzing a portion of the at least one polyhydroxyalkanoate by reaction with the base for a reaction time interval, wherein the weight average molecular weight of the at least one polyhydroxyalkanoate is reduced to a final weight average molecular weight which is less than the initial weight average molecular weight;
stopping the reaction by addition of a quenching acid in an amount sufficient to establish a pH less than 12. 0 (preferably from about 5.0 to about 7.5) in the dispersion; and
filtering precipitated salts from the dispersion,
wherein all weight average molecular weights are determined in accordance with ASTM D5296, and
wherein the at least one polyhydroxyalkanoate in the dispersion comprises particles having an average particles size from about particles having an average particle size from about 10 nanometers to about 50 microns, as determined using dynamic light scattering in accordance with ISO 22412:2017.

Embodiment 2. The method of Embodiment 1, wherein the initial weight average molecular weight is from about 500,000 to about 5,000,000 Daltons, as determined by ASTM D5296.

Embodiment 3. The method of Embodiments 1 or 2, wherein the final weight average molecular weight is from about 50,000 to 700,000 Daltons, more preferably from about 250,000 to about 500,000 Daltons, and even more preferably 350,000 to about 500,000 Daltons, as determined by ASTM D5296.

Embodiment 4. The method of any of the preceding Embodiments, wherein the final weight average molecular weight is from about 10 to about 95 percent of the initial weight average molecular weight, wherein both weight average molecular weights are determined in accordance with ASTM D5296.

Embodiment 5. The method of any of the preceding Embodiments, wherein the final weight average molecular weight is from about 35 to about 70 percent of the initial weight average molecular weight, wherein both weight average molecular weights are determined in accordance with ASTM D5296.

Embodiment 6. The method of any of the preceding Embodiments, wherein the solvent is selected from the group consisting of water, methanol, ethanol, isopropanol, and mixtures thereof.

Embodiment 7. The method of any of the preceding Embodiments, wherein the solvent comprises ethanol, and the reaction time interval is from about 2 to about 60 minutes, more preferably from about 5 to about 30 minutes.

Embodiment 8. The method of any of the preceding Embodiments, wherein the solvent comprises water, and the reaction time interval is from about 1 to about 48 hours.

Embodiment 9. The method of any of the preceding Embodiments, wherein the base has a pKb which is less than 1.

Embodiment 10. The method of Embodiment 9, wherein the base is selected from the group consisting of alkali hydroxide, alkaline earth hydroxides, and mixtures thereof.

Embodiment 11. The method of any of Embodiments 1-8, wherein the base has a pKb from about 1 to about 5.

Embodiment 12. The method of Embodiment 11, wherein the base is selected from the group consisting of ammonium hydroxide, aniline, ammonia, and mixtures thereof.

Embodiment 13. The method of any of the preceding Embodiments, wherein the dispersion has a solids content from about 5 to about 20 percent prior to the addition of the base.

Embodiment 14. The method of any of the preceding Embodiments, wherein the quenching acid is selected from the group consisting of hydrochloric acid, sulfuric acid, nitric acid, hydrobromic acid, hydroiodic acid, perchloric acid, or chloric acid, acetic acid, citric acid, phosphoric acid, glycolic acid, nitrous acid, sulfurous acid, oxalic acid, benzoic acid, formic acid, and mixtures thereof.

Embodiment 15. The method of any of the preceding Embodiments, wherein the hydrolyzing is carried out at a temperature from about 20° C. to about 60° C.

Embodiment 16. The method of any of the preceding Embodiments, wherein the dispersion further comprises at least one surfactant selected from the group consisting of anionic surfactants, cationic surfactants, amphoteric surfactants, nonionic surfactants, and mixtures thereof.

Embodiment 17. The method of any of the preceding Embodiments, wherein the dispersion is prepared using sonication, low shear mixing, and/or ultra-high shear mixing.

Embodiment 18. The method of any of the preceding Embodiments, further comprising a step prior to preparing the dispersion, of synthesizing the at least one polyhydroxyalkanoate, by:
mixing a biomass comprising bacteria with a carbon source,
fermenting the biomass and the carbon so that the bacteria of the biomass consume at least a portion of the carbon source and synthesize at least one poly(hydroxyalkanoate) having an initial weight average molecular weight from about 500,000 Daltons to about 5,000,000 Daltons, and
separating the at least one poly(hydroxyalkanoate) from the biomass.

Embodiment 19. The method of any of the preceding Embodiments, wherein the method produces a polyhydroxyalkanoate having a polydispersity index (PDI) from about 1.0 to about 5.0 and preferably from about 2.0 to about 4.0 when measured via gel permeation chromatography according to ASTM D5296.

Embodiment 20. A method for producing a polyhydroxyalkanoate, comprising the steps of:
preparing a dispersion comprising from about 10 to about 90 weight percent of at least one polyhydroxyalkanoate, having an initial weight average molecular weight, and from about 500,000 Daltons to about 5,000,000 Daltons and from about 10 to 90 weight percent of a solvent selected from the group consisting of water, saturated and unsaturated alkyl alcohols having from 1 to 10 carbon atoms, and mixtures thereof;
adding an acid to the dispersion in an amount sufficient to provide a pH in the dispersion from about 1 to about 3;
hydrolyzing a portion of the at least one polyhydroxyalkanoate by reaction with the acid for a reaction time interval, wherein the weight average molecular weight of the at least one polyhydroxyalkanoate is reduced to a final weight average molecular weight which is less than the initial weight average molecular weight;
stopping the reaction by the addition of a quenching base in an amount sufficient to establish a pH from about 5.0 to about 7.5 in the dispersion; and
filtering precipitated salts from the dispersion,
wherein all weight average molecular weights are determined in accordance with ASTM D5296, and
wherein the at least one polyhydroxyalkanoate in the dispersion comprises particles having an average particles size from about particles having an average particle size from about 10 nanometers to about 50 microns, as determined using dynamic light scattering in accordance with ISO 22412:2017.

Embodiment 21. The method of Embodiment 20, wherein the initial weight average molecular weight is from about 500,000 to about 5,000,000 Daltons, as determined by ASTM D5296.

Embodiment 22. The method of Embodiments 20 or 21, wherein the final weight average molecular weight is from about from about 50,000 to 700,000 Daltons, more preferably from about 250,000 to about 500,000 Daltons, and even more preferably 350,000 to about 500,000 Daltons, as determined by ASTM D5296.

Embodiment 23. The method of any of Embodiments 20-22, wherein the final weight average molecular weight is from about 10 to about 95 percent of the initial weight average molecular weight, wherein both weight average molecular weights are determined in accordance with ASTM D5296.

Embodiment 24. The method of any of Embodiments 20-22, wherein the final weight average molecular weight is from about 35 to about 70 percent of the initial weight average molecular weight, wherein both weight average molecular weights are determined in accordance with ASTM D5296.

Embodiment 25. The method of any of Embodiments 20-23, wherein the solvent is selected from the group consisting of water, methanol, ethanol, isopropanol, and mixtures thereof.

Embodiment 26. The method of any of Embodiments 20-24, wherein the solvent comprises ethanol, and the reaction time interval is from about 2 to about 60 minutes, more preferably from about 5 to about 30 minutes.

Embodiment 27. The method of any of Embodiments 20-24, wherein the solvent comprises water, and the reaction time interval is from about 1 to about 48 hours.

Embodiment 28. The method of any of Embodiments 20-27, wherein the acid has a pKₐ which is less than 0.

Embodiment 29. The method of Embodiment 28, wherein the acid is selected from the group consisting of hydrochloric acid, sulfuric acid, nitric acid, hydrobromic acid, hydroiodic acid, perchloric acid, or chloric acid, and mixtures thereof.

Embodiment 30. The method of any of Embodiments 20-27, wherein the acid has a pKa which is less than 14 but more than 0.

Embodiment 31. The method of Embodiment 30, wherein the acid is selected from the group consisting of acetic acid, citric acid, phosphoric acid, glycolic acid, nitrous acid, sulfurous acid, oxalic acid, benzoic acid, formic acid, and mixtures thereof.

Embodiment 32. The method of any of Embodiments 20-30, wherein the dispersion has a solids content from about 5 to about 20 percent prior to addition of the acid.

Embodiment 33. The method of any of Embodiments 29-31, wherein the quenching base is selected from the group consisting of ammonium hydroxide, aniline, ammonia, and mixtures thereof

Embodiment 34. The method of any of Embodiments 20-33, wherein the hydrolyzing is carried out at a temperature from about 20° C. to about 60° C.

Embodiment 35. The method of any of Embodiments 20-34, wherein the dispersion further comprises surfactants from the group consisting of anionic surfactants, cationic surfactants, amphoteric surfactants, nonionic surfactants, and mixtures thereof.

Embodiment 36. The method of any of Embodiments 20-35, wherein the dispersion is prepared using sonication, low shear mixing, and/or ultra-high shear mixing.

Embodiment 37. The method of any of Embodiments 20-36, further comprising a step, prior to preparing the dispersion, of synthesizing the at least one polyhydroxyalkanoate, by:
mixing a biomass comprising bacteria with a carbon source,
fermenting the biomass and the carbon so that the bacteria of the biomass consume at least a portion of the carbon source and synthesize at least one poly(hydroxyalkanoate) having an initial weight average molecular weight from about 500,000 Daltons to about 5,000,000 Daltons, and
separating the at least one poly(hydroxyalkanoate) from the biomass.

Embodiment 38. The method of any of Embodiments 20-37, wherein the method produces a polyhydroxyalkanoate having a polydispersity index (PDI) from about 1.0 to about 5.0 and preferably from about 2.0 to about 4.0 when measured via gel permeation chromatography according to ASTM D5296.

### Examples

The following non-limiting examples illustrate various additional aspects of the invention. Unless otherwise indicated, temperatures are in degrees Celsius, percentages are by weight based on the dry weight of the formulation, and weight average molecular weight values are determined in accordance with ASTM D5296.

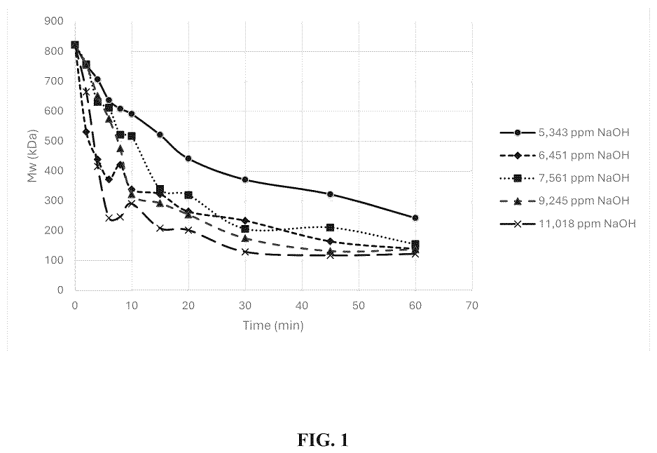

Example 1. An ethanol slurry of a PHA copolymer consisting of 88% butyrate monomer and 12% hexanoate monomer was prepared at 20 weight percent PHA solids and 80 weight percent ethanol. This PHA had a weight average molecular weight of 822 kDa. Sodium hydroxide (NaOH) was introduced into the slurry under stirring at varying concentrations, ranging from about 5,000 ppm to about 11,000 ppm. Each concentration of NaOH resulted in a pH of >13.5 in the slurry. Samples were taken and quenched with citric acid at varying time intervals over an hour, and the weight average molecular weight and polydispersity index were measured for each sample. The results are shown in Tables 1 and 2 below and also illustrated in FIG. 1. The hydrolysis plot, as seen from Table 1 and FIG. 1 shows that higher concentrations of NaOH degraded the PHA faster than lower concentrations of NaOH.

TABLE 1

| | Weight Average Molecular Weight (kDa) | | | | |
|---|---|---|---|---|---|
| Time | 5,434 ppm | 6,451 ppm | 7,561 ppm | 9,245 ppm | 11,018 ppm |
| (min) | NaOH | NaOH | NaOH | NaOH | NaOH |
| 0 | 822 | 822 | 822 | 822 | 822 |
| 2 | 755 | 530 | 756 | 754 | 664 |
| 4 | 706 | 438 | 630 | 651 | 415 |
| 6 | 636 | 371 | 611 | 574 | 242 |
| 8 | 607 | 420 | 520 | 475 | 246 |
| 10 | 590 | 338 | 516 | 321 | 290 |
| 15 | 520 | 322 | 339 | 291 | 208 |
| 20 | 441 | 364 | 319 | 253 | 201 |
| 30 | 370 | 233 | 206 | 174 | 219 |
| 45 | 321 | 164 | 210 | 131 | 117 |
| 60 | 242 | 138 | 154 | 137 | 122 |

TABLE 2

| | Polydispersity Index (PDI) | | | | |
|---|---|---|---|---|---|
| Time | 5,434 ppm | 6,451 ppm | 7,561 ppm | 9,245 ppm | 11,018 ppm |
| (min) | NaOH | NaOH | NaOH | NaOH | NaOH |
| 0 | 3.4 | 3.4 | 3.4 | 3.4 | 3.4 |
| 2 | 4.6 | 3.1 | 3.1 | 3.1 | 3.6 |
| 4 | 3.8 | 4.1 | 3.3 | 2.8 | 4.6 |
| 6 | 4.1 | 4.2 | 3.1 | 2.8 | 3.6 |
| 8 | 4.1 | 3.5 | 3.2 | 2.6 | 3.9 |
| 10 | 3.6 | 3.5 | 3.5 | 3.5 | 4.7 |
| 15 | 3.4 | 3.6 | 4.6 | 3.1 | 3.6 |
| 20 | 3.8 | 3.2 | 3.8 | 3.0 | 4.2 |
| 30 | 3.4 | 3.4 | 4.7 | 4.4 | 4.9 |
| 45 | 3.5 | 4.5 | 3.7 | 5.3 | 5.0 |
| 60 | 4.0 | 5.3 | 5.0 | 4.7 | 3.5 |

Example 2. An ethanol slurry of a PHA copolymer consisting of 91% butyrate monomer and 9% hexanoate monomer was prepared at 20 weight percent PHA solids and 80 weight percent ethanol. This PHA had a weight average molecular weight of 1,060 kDa. Sodium hydroxide (NaOH) was introduced into the slurry under stirring at varying concentrations, ranging from about 1,000 ppm to about 8,000 ppm. Each concentration of NaOH resulted in a pH of >13.5 in the slurry. Samples were taken and quenched with citric acid after 15 minutes and the weight average molecular weight and polydispersity index were measured for each sample. The resulting degradation data is shown in Table 3.

TABLE 3

| NaOH | Weight Average Molecular | Polydispersity |
|---|---|---|
| Concentration | Weight (kDa) | Index (PDI) |
| 1,000 ppm | 914 | 2.4 |
| 2,000 ppm | 600 | 2.7 |
| 3,000 ppm | 402 | 3.4 |
| 4,000 ppm | 269 | 4.2 |
| 8,000 ppm | 122 | 4.2 |

Example 3. An ethanol slurry of a PHA copolymer consisting of 88% butyrate monomer and 12% hexanoate monomer was prepared at 20 weight percent PHA solids and 80 weight percent ethanol. This PHA had a weight average molecular weight of 630 kDa. Sodium hydroxide (NaOH) was introduced into the slurry under stirring at varying concentrations, ranging from about 3,215 ppm to about 12,000 ppm. Each concentration of base resulted in a pH of >13.5 in the slurry. Samples were taken and quenched with citric acid after 15 minutes and the weight average molecular weight and polydispersity index were measured for each sample. The resulting degradation data is shown in Table 4.

TABLE 4

| | | Weight Average Molecular | Polydispersity |
|---|---|---|---|
| NaOH Concentration | | Weight (kDa) | Index (PDI) |
| 3,605 | ppm | 197 | 2.1 |
| 4,500 | ppm | 156 | 2.0 |
| 6,000 | ppm | 88 | 2.2 |
| 7,500 | ppm | 67 | 2.4 |
| 10,500 | ppm | 49 | 2.8 |
| 12,000 | ppm | 34 | 2.3 |

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for producing a polyhydroxyalkanoate, comprising
preparing a dispersion comprising from 10 to 90 weight percent of at least one polyhydroxyalkanoate, having an initial weight average molecular weight from 500,000 Daltons to 5,000,000 Daltons, and from 10 to 90 weight percent of a solvent selected from the group consisting of water, saturated and unsaturated alkyl alcohols having from 1 to 10 carbon atoms, and mixtures thereof;
adding a base to the dispersion in an amount sufficient to provide a pH in the dispersion from 12 to 14;
hydrolyzing a portion of the at least one polyhydroxyalkanoate by reaction with the base for a reaction time interval, wherein the weight average molecular weight of the at least one polyhydroxyalkanoate is reduced to a final weight average molecular weight which is less than the initial weight average molecular weight;
stopping the reaction by addition of a quenching acid in an amount sufficient to establish a pH less than 12.0 in the dispersion; and
filtering precipitated salts from the dispersion,
wherein all weight average molecular weights are determined in accordance with ASTM D5296, and wherein the at least one polyhydroxyalkanoate in the dispersion comprises particles having an average particle size from 10 nanometers to 50 microns, as determined using dynamic light scattering in accordance with ISO 22412:2017.

2. The method of claim 1, wherein the initial weight average molecular weight is from 500,000 to 5,000,000 Daltons, as determined by ASTM D5296.

3. The method of claim 1, wherein the final weight average molecular weight is from 50,000 to 700,000 Daltons, as determined by ASTM D5296.

4. The method of claim 1, wherein the final weight average molecular weight is from 10 to 95 percent of the initial weight average molecular weight, wherein both weight average molecular weights are determined in accordance with ASTM D5296.

5. The method of claim 1, wherein the solvent is selected from the group consisting of water, methanol, ethanol, isopropanol, and mixtures thereof.

6. The method of claim 1, wherein the solvent comprises ethanol, and the reaction time interval is from 2 to 60 minutes.

7. The method of claim 1, wherein the solvent comprises water, and the reaction time interval is from 1 to 48 hours.

8. The method of claim 1, wherein the base has a pKb which is less than 1.

9. The method of claim 8, wherein the base is selected from the group consisting of alkali hydroxide, alkaline earth hydroxides, and mixtures thereof.

10. The method of claim 1, wherein the base has a pKb from 1 to 5.

11. The method of claim 10, wherein the base is selected from the group consisting of ammonium hydroxide, aniline, ammonia, and mixtures thereof.

12. The method of claim 1, wherein the dispersion has a solids content from 5 to 20 percent prior to addition of the base.

13. The method of claim 1, wherein the quenching acid is selected from the group consisting of hydrochloric acid, sulfuric acid, nitric acid, hydrobromic acid, hydroiodic acid, perchloric acid, or chloric acid, acetic acid, citric acid, phosphoric acid, glycolic acid, nitrous acid, sulfurous acid, oxalic acid, benzoic acid, formic acid, and mixtures thereof.

14. The method of claim 1, wherein the hydrolyzing is carried out at a temperature from 20° C. to 60° C.

15. The method of claim 1, wherein the dispersion further comprises at least one surfactant selected from the group consisting of anionic surfactants, cationic surfactants, amphoteric surfactants, nonionic surfactants, and mixtures thereof.

16. The method of claim 1, wherein the dispersion is prepared using sonication, low shear mixing, and/or ultra-high shear mixing.

17. The method of claim 1, further comprising a step, prior to preparing the dispersion, of synthesizing the at least one polyhydroxyalkanoate by:
mixing a biomass comprising bacteria with a carbon source,
fermenting the biomass and the carbon so that the bacteria of the biomass consumes at least a portion of the carbon source and synthesize at least one poly(hydroxyalkanoate) having an initial weight average molecular weight from 500,000 Daltons to 5,000,000 Daltons, and
separating the at least one poly(hydroxyalkanoate) from the biomass.
